(19) United States
(12) Patent Application Publication
(10) Pub. No.: US 2016/0320967 A1
(43) Pub. Date: Nov. 3, 2016

(54) Receive Side Packet Aggregation

(71) Applicant: Broadcom Corporation, Irvine, CA (US)

(72) Inventors: Predrag Kostic, Burnaby (CA); Milomir Aleksic, Vancouver (CA); Vahid Marandi, Mission Viejo, CA (US); Stanley Siu, Sunnyvale, CA (US); Ting-Kuo Yu, Beverly Hills, CA (US)

(21) Appl. No.: 14/863,106

(22) Filed: Sep. 23, 2015

Related U.S. Application Data
(60) Provisional application No. 62/154,205, filed on Apr. 29, 2015.

(51) Int. Cl. G06F 3/06

(52) U.S. Cl. CPC G06F 3/061; G06F 3/0631; G06F 3/067

(57) ABSTRACT

A system for enhanced resource utilization includes a network interface with access to memory of a device, in communication with an operating system of the device. The system receives, from the operating system, an identification of a predetermined amount of the memory for a packet buffer, store multiple packets in the allocated memory. A total size of the multiple packets is smaller than or equal to the predetermined amount of memory. The system generates a status record for each received packet stored in the allocated memory, and stores the generated status records in the allocated memory. The system also allocates a socket buffer for each packet stored in the allocated memory such that the socket buffer has reference to the corresponding packet in the allocated memory.

### RELATED APPLICATIONS

The present application claims the benefit of and priority to U.S. Provisional Application No. 62/154,205, entitled “Receive Side Packet Aggregation,” filed Apr. 29, 2015, the entirety of which is hereby incorporated by reference

### FIELD OF THE DISCLOSURE

This disclosure generally relates to systems and methods for data packet aggregation in packet buffers. In particular, this disclosure relates to systems and methods for aggregating multiple received packets in a single packet buffer to improve effective system bus and system memory throughput.

### BACKGROUND OF THE DISCLOSURE

Network packet size distributions are typically random, making system bus and memory subsystem bandwidth calculations difficult in devices including a networking subsystem. For long streams of minimum-sized packets, a host CPU may be overwhelmed with interrupts, requiring interrupt moderation techniques to be deployed. For example, when back-to-back 65 byes (B) packets are received via the network subsystem where the system bus supports 64B transaction size, any 65B transaction is “broken” into two (a 64B transaction and a 1B transaction). The 1B transaction is arbitrated separately, thus incurring the same arbitration latency as the 64B transaction. Moreover, the network subsystem uses only a fraction of the system bus bandwidth, incurring a reduced effective throughput, a reduced effective memory throughput, an inefficient usage of memory space, and a significant number of system interrupts.

### BRIEF DESCRIPTION OF THE DRAWINGS

Various objects, aspects, features, and advantages of the disclosure will become more apparent and better understood by referring to the detailed description taken in conjunction with the accompanying drawings, in which like reference characters identify corresponding elements throughout. In the drawings, like reference numbers generally indicate identical, functionally similar, and/or structurally similar elements.

FIG. 1 is a block diagram of an implementation of a network processing device for packet processing in accordance with an embodiment;

FIG. 2 is a block diagram of an implementation of a receive side packet aggregation system for enhanced resource utilization in accordance with a first embodiment;

FIG. 3 is a block diagram of an implementation of a receive side packet aggregation system for enhanced resource utilization in accordance with a second embodiment;

FIG. 4 is a block diagram of an implementation of a receive side packet aggregation system for enhanced resource utilization in accordance with a third embodiment;

FIG. 5 is a flow chart of an implementation of a method for processing packets using a receive side packet aggregation system in accordance with an embodiment;

FIG. 6 is a flow chart of an implementation of a method for processing packets from a packet buffer using a receive side packet aggregation system in accordance with an embodiment;

FIG. 7 is a flow chart of an implementation of a method for processing packets and deallocating a socket buffer and packet buffer in accordance with an embodiment;

FIG. 8A is a block diagram depicting an embodiment of a network environment including one or more access points in communication with one or more devices or stations; and

FIGS. 8B and 8C are block diagrams depicting embodiments of computing devices useful in connection with the methods and systems described herein.

The details of various embodiments of the methods and systems are set forth in the accompanying drawings and the description below.

### DETAILED DESCRIPTION

For purposes of reading the description of the various embodiments below, the following descriptions of the sections of the specification and their respective contents may be helpful:
Section A describes embodiments of systems and methods for receive-side packet aggregation; and
Section B describes a network environment and computing environment which may be useful for practicing embodiments described herein.

### A. Receive-Side Packet Aggregation

Multiple packets may be aggregated within a single packet buffer, and multiple socket buffers (SKBs) may be generated, each pointing to a different starting location within the single buffer. Packets may be read from the packet buffer in transactions of a size to fully utilize the subsystem (e.g. 64B), with only the last transaction being of non-fully-utilized size (e.g., 1B). Such packet aggregation can improve system bus bandwidth utilization so that majority of transactions fully utilize an available system bus bandwidth, and thus can reduce the overall system bus latency. Memory write bandwidth utilization also can be improved so that majority of transactions have size of full memory (e.g., DRAM) burst length. Moreover, by aggregating smaller packets in a packet buffer, the operating system can allocate fewer buffers than without aggregation, thereby more efficiently using the available system DRAM space. Furthermore, such packet aggregation can allow the system interrupt to be generated based on the number of consumed packet buffers instead of that of received packets, thereby greatly reducing the total number of RX interrupts. In some implementations, the receive-side packet aggregation uses standard Operating System (OS) methods and functions for allocating/deallocating memory and handling packets; accordingly, in such implementations, there is no need for to modify the OS kernel.

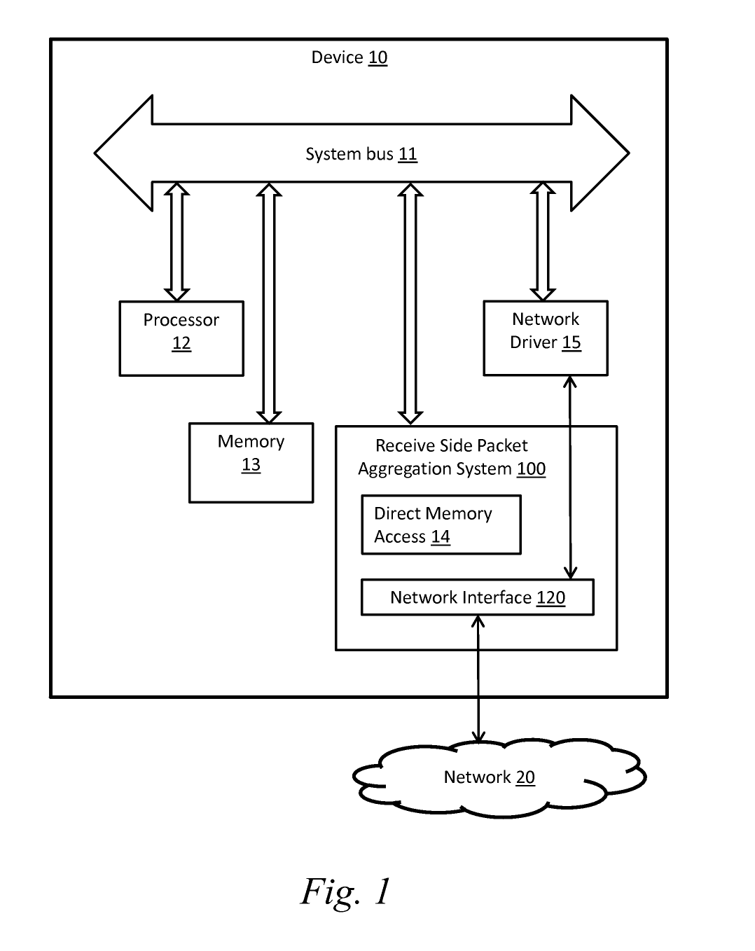

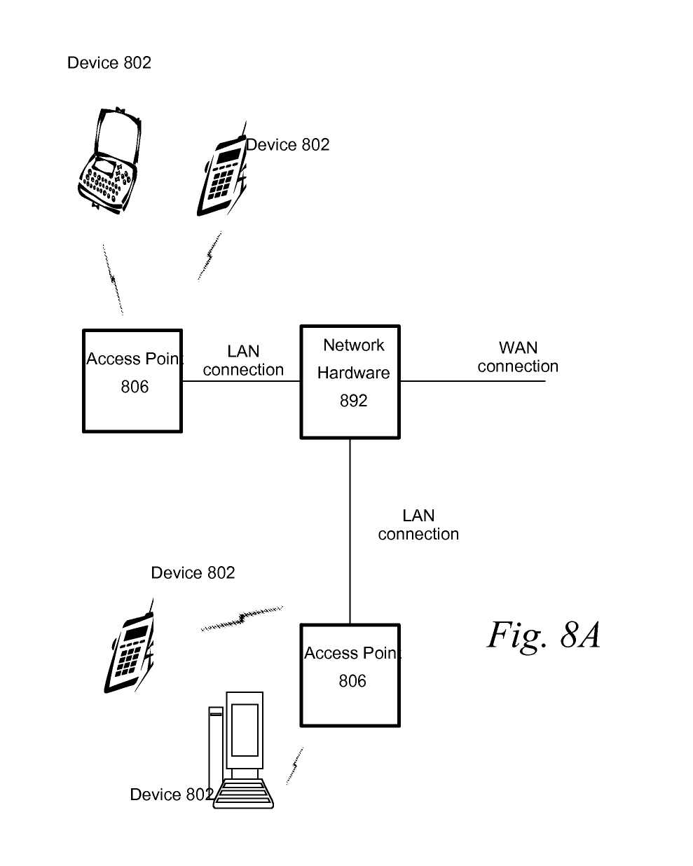

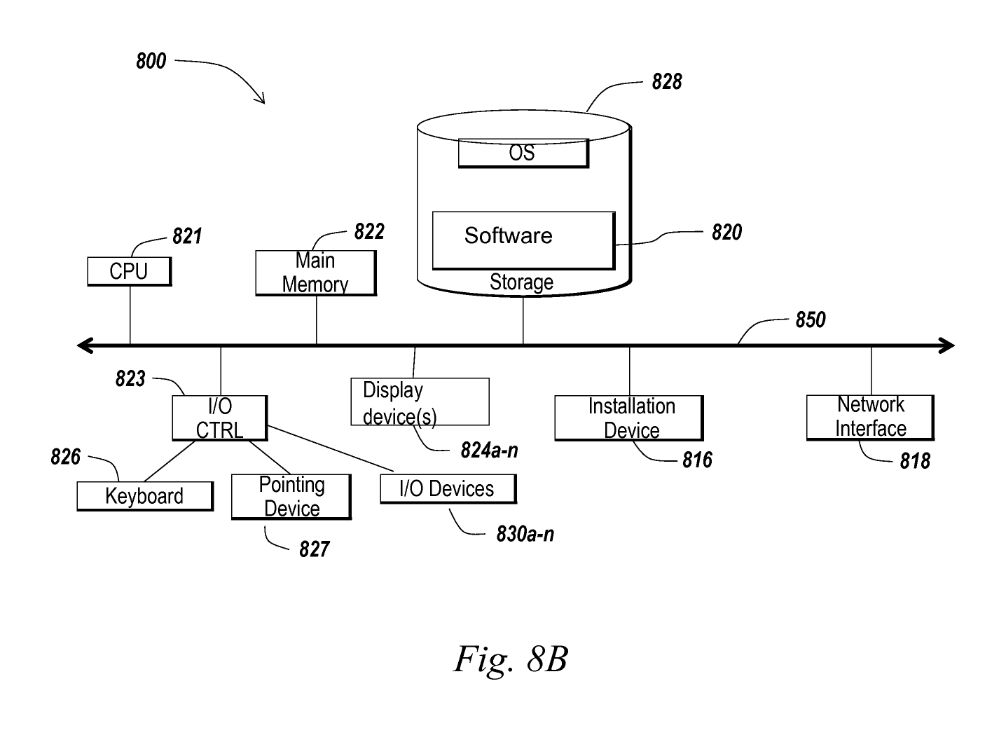

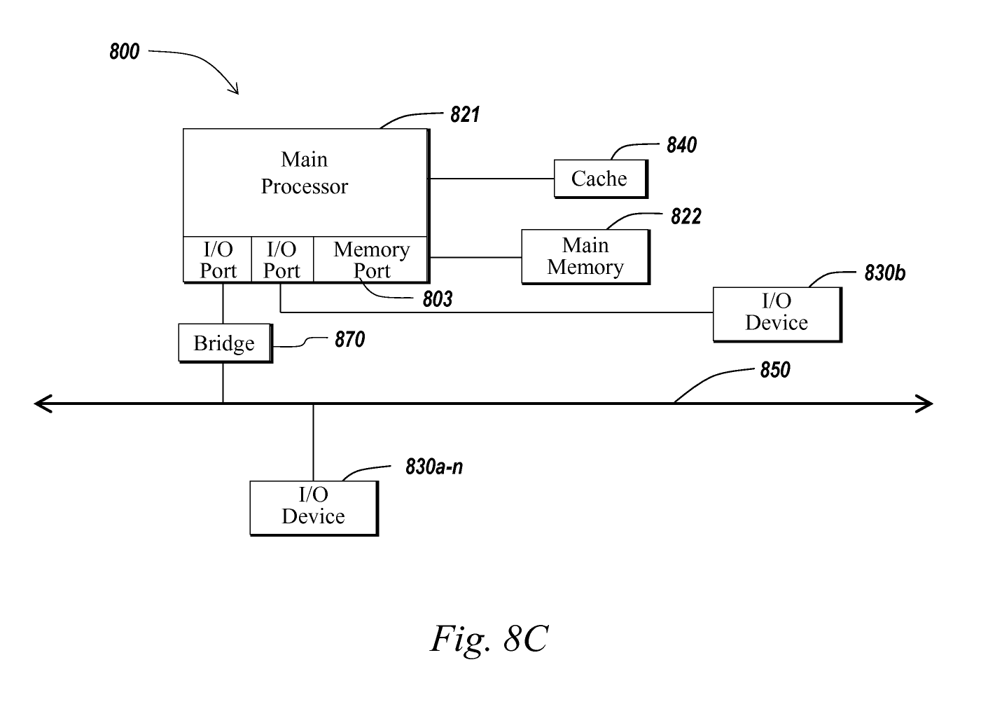

FIG. 1 is a block diagram of an implementation of a network processing device 10 for packet processing in accordance with an embodiment. The device 10 may include a system bus 11, a processor 12, memory 13, a network driver 15 (e.g., an Ethernet driver), and a receive side packet aggregation system 100. The processor 12, discussed in more detail below in connection with FIGS. 8A-8C, may include a microprocessor, a central processing unit (CPU), a graphic processing unit (GPU) or the like. The receive side packet aggregation system 100 may include a direct memory access (DMA) 14, and a network interface 120 with access to the memory 13 of the device 10 in communication with an operating system (not shown) of the device 10. The receive side packet aggregation system 100 may be implemented in the network interface 120, which is hardware or combination of hardware and software/firmware. The network interface 120 may be a wired or wireless network interface and may be commonly referred to as a hardware network device, a network interface card (NIC), a network adapter, an IEEE 802.3 Ethernet interface card, a 802.11 WiFi (Wireless Ethernet) interface, or by other similar terms. The network interface 120 may operate in conjunction with system software (e.g., the network driver 15, OS kernel, etc.) running on the processor 12, to send or receive packets (e.g., Ethernet packets) in communication with a network 20 (e.g., the Internet), as discussed in more detail below in connection with FIGS. 8A-8C. The network interface 120 may include the DMA 14 to perform DMA function. Alternatively, the receive side packet aggregation system 100 may be an application, service, daemon, routine, or other executable logic executed by a processor 12 or a co-processor of a network interface 120. The receive side packet aggregation system 100 may be part of a networking protocol stack, network driver, operating system of the device 10.

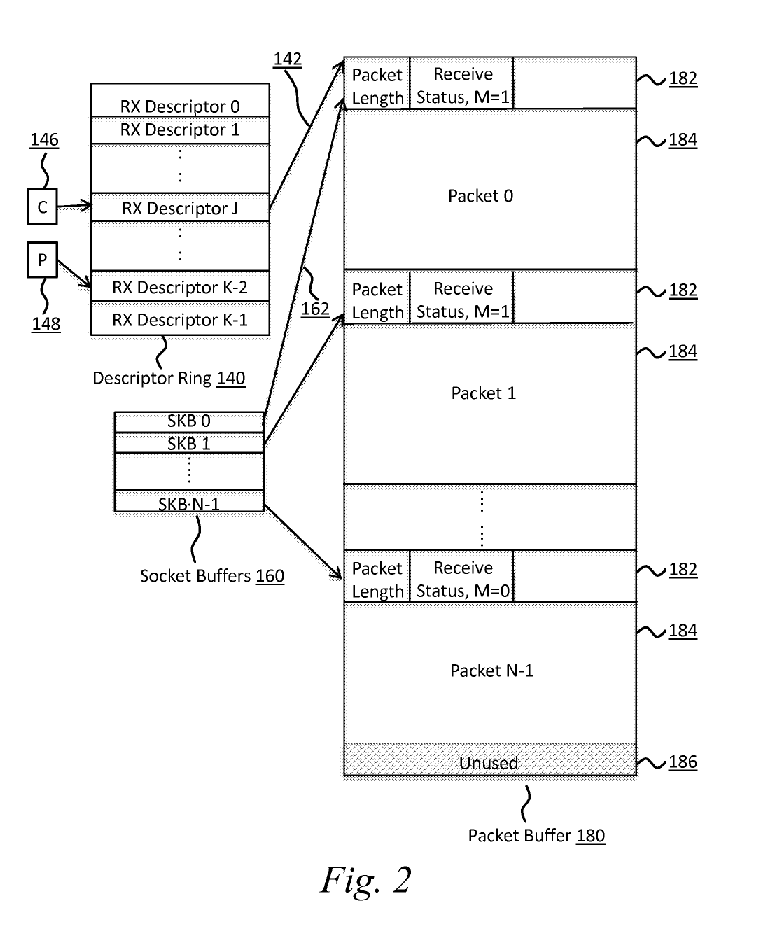

FIG. 2 is a block diagram of an implementation of a receive side packet aggregation system for enhanced resource utilization in accordance with a first embodiment. The network interface 120 (see FIG. 1) may receive, from the network driver, location information (e.g., memory address) or an identification of a predetermined amount of memory for a packet buffer 180. In an embodiment, the DMA 14 (see FIG. 1) may receive, from the network driver, the location information. For example, the predetermined amount of memory for the packet buffer 180 may be 1K bytes (B), 2 KB, 4 KB, or any other such amount, such as based on a maximum transmission unit of an Ethernet frame (e.g. 1518B or larger). The predetermined amount of memory may be a controlled parameter, and can be selected for the target system for various implementations. For example, the system may allocate packet buffers that are larger than 2 KB to improve system bus and system bus bandwidth utilization, but this may lead to other inefficiencies (e.g., ineffective use of memory space in implementations in which packet sizes are limited, such as network packets with a maximum transmission unit size of 1500B).

The network interface 120 may store, in the packet buffer 180, multiple packets 184 (e.g., packet “0”, packet “1”, . . . , packet “N−1”, where N denotes the number of packets stored in the packet buffer 180), a total size of which is smaller than the predetermined amount of memory (in other implementations in which packets are counted starting at 1, the packets 184 may be identified as packet “1” through packet “N”).

The network interface 120 may also generate a status record, called a receive status block (RSB) 182, for each received packet 184 stored in the packet buffer 180, and store the generated RSBs in the packet buffer 180. Each RSB 182 for a corresponding received packet may include a predetermined bit (e.g., a “more” or “M” bit) which is set to a first value, e.g., “1”, to indicate the presence of a packet stored at a location in the packet buffer 180 following that packet (indicating “more” packets exist in the buffer), or set to a second value, e.g., “0”, to indicate the absence of such next packet. For example, as shown in the example of FIG. 2, the topmost RSB 182 corresponding to the packet “0” includes the “M” bit set to “1” to indicate the presence of the packet “1”, while the bottommost RSB 182 corresponding to the packet “N−1” includes the “M” bit set to “0” to indicate the absence of any packet following the packet “N−1”. Each RSB 182 for a corresponding received packet includes an identification of a length of the corresponding received packet (e.g., “Packet Length” field). Each RSB 182 also may include an identification of various receive statuses (e.g., “Receive Status” field) such as an End of Packet (EOP), a Start of Packet (SOP), packet type, etc.

As a new packet arrives, the network interface 120 may store a new RSB corresponding to the packet by counting bytes to identify where is a boundary of the packet buffer. Iteratively for each received packet, the network interface 120 may add the packet length identified in each RSB stored in the packet buffer 180 until reaching an RSB having the “M” bit set to the second value, e.g., “0”, and store the received packet in the packet buffer 180 at a start location equal to the added packet lengths. The network interface 120 may set the “M” bit of the previously last RSB to the first value, e.g., “1”, store a new RSB corresponding to the received packet in the packet buffer 180, and set the “M” bit of the new RSB to “0”. In this way, the network interface 120 may store multiple packets 184 in the packet buffer 180, such that the total size of packets and their corresponding RSBs in the packet buffer 180 is smaller than the predetermined amount of memory, e.g., 2 KB, and the size of unused space 186 in the packet buffer 180 is the difference between the total size and the predetermined amount of memory.

Referring to FIG. 1, the processor 12 may access the memory 13 of the device 10 via the system bus 11 with a predetermined maximum throughput. The processor 12 may read a portion of a first packet (e.g., packet “0”) of the multiple packets 184 and a portion of a second packet (e.g., packet “1”) of the multiple packets, such that the portions of the first packet and second packet are equal in size according to the predetermined maximum throughput (e.g., size of 64B to fully utilize the bandwidth of the system bus). For example, the portions of the first packet and second packet can have a maximum transaction size (e.g., size of 64B to fully utilize the bandwidth of the system bus) according to the predetermined maximum throughput. The predetermined maximum throughput may be calculated based on a network interface link rate and supported packet sizes. For example, the predetermined maximum throughput for the system bus is defined as the number of maximum transactions per second.

With reference to FIGS. 1 and 2, the device 10 may include a descriptor ring 140 and socket buffers 160 in the memory 13 for packet processing. The descriptor ring 140 may be stored in the network interface 120 or in the memory 13 and include multiple receive descriptors (e.g., RX descriptor “0”, RX descriptor “1”, . . . , RX descriptor “K−1”, where K denotes the total number of RX descriptors). Each RX descriptor may have location information 142 of a corresponding packet buffer 180, e.g., the memory address of the starting byte (or word) of the corresponding packet buffer 180. Referring to FIG. 2, for example, the RX descriptor J has the memory address of the first RSB 182 of the packet buffer 180 corresponding to the RX descriptor J. The packet occupancy of the descriptor ring 140 may be managed using two memory spaces respectively indicating a producer index 148 and a consumer index 146. The producer index 148 may have location information (e.g., memory address) of an RX descriptor that points to a most recently allocated packet buffer. The consumer index 146 may have location information of an RX descriptor that points to a packet buffer whose packets have been most recently processed or are currently being processed by the network processing device 10. Therefore, if the producer index 148 and the consumer index 146 have the same location information of an RX descriptor, it will indicate that there is no packet buffer awaiting the processing of packets. On the other hand, if the producer index 148 and the consumer index 146 have different location information from each other, it will indicate that there is at least one packet buffer awaiting the processing of packets.

The socket buffers 160 may include multiple socket buffers (e.g., SKB “0”, SKB “1”, . . . , SKB “N−1”), each of which has location information (e.g., memory address) 162 of a corresponding packet 184 stored in the packet buffer 180. For example, referring to FIG. 2, SKB “0” includes the memory address of or points to packet “0”, SKB “1” includes the memory address of or points to packet “1”, etc. Each socket buffer may also include a pointer to the original buffer 180, used by a destructor function to free the buffer once all packets have been processed.

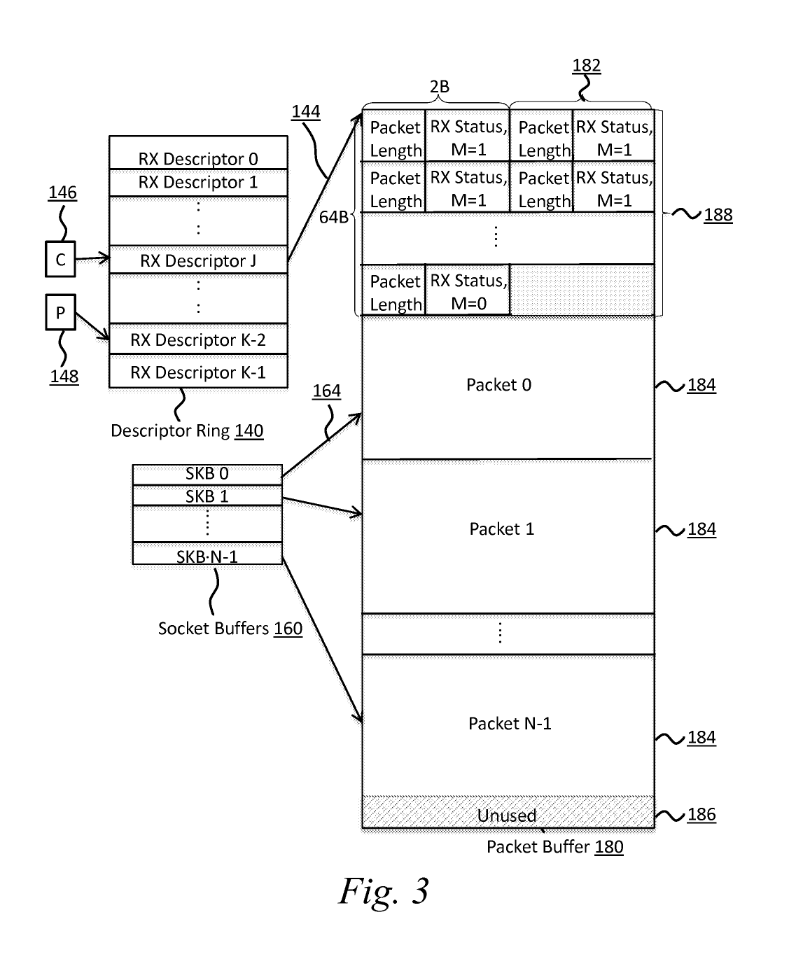

FIG. 3 is a block diagram of an implementation of a receive side packet aggregation system for enhanced resource utilization in accordance with a second embodiment. According to the second embodiment, the network interface 120 may store RSBs 182, which correspond to the entirety of the received packets 184 stored in the packet buffer 180, as an RSB block 188 at the start location of the packet buffer 180, so that the RSB block 188 is stored separately from the block of the entirety of the received packets 184 in the packet buffer 180. For example, referring to FIG. 3, the RSB block of 64B size may store up to thirty one RSBs of 2B size. Because, in implementations using a 2 KB buffer, the buffer 180 can contain thirty one 64B packets and one 64B RSB block, only thirty one RSBs of 2B size are needed. If, for example, some network interface supports smaller packets, the RSB block may be increased to 96B and have more RSBs corresponding to the number of packets per packet buffer. Similarly, if a larger packet buffer, for example 4 KB, is used, the RSB block may be increased to store more packets.

With the configuration of FIG. 3, the network driver may need to read only the first 64B of the packet buffer to access all RSBs, thereby reducing the processor time and memory accesses, as well as optimizing throughput of a corresponding size system bus. For example, rather than reading 2B of the first RSB with 62B of the bus unutilized, the network driver may read all 64B in a single pass and cache the information from the additional RSBs. In some implementations, the RSB block may store up to a predetermined number of RSBs. Therefore, in various implementations, the network interface 120 may stop storing a received packet by determining that the packet buffer is filled up, when the storing of the packet would cause no unused space 186, or when the total number of stored packets would exceed the predetermined number of RSBs (e.g., thirty one in case of 2 KB packet buffer and 64B packet size).

Referring to FIG. 3, each RX descriptor may have location information 144 of a corresponding packet buffer 180, e.g., the memory address of the starting byte (or word) of the packet buffer 180 corresponding to that RX descriptor. Referring to FIG. 3, for example, the RX descriptor J has the memory address of the first byte (or word) of the RSB block 188 in the packet buffer 180 corresponding to the RX descriptor J. Each of the socket buffers 160 may have location information 164 (e.g., starting memory address and/or ending memory address) of a corresponding packet stored in the packet buffer 180. For example, referring to FIG. 3, SKB “0”, SKB “1”, . . . , SKB “N−1” may have the memory addresses of the packet “0”, packet “1”, . . . , packet “N−1”, respectively. As discussed above in connection with FIG. 2, each of the socket buffers 160 may also have location information or a pointer to the original buffer 180, and may be used to free the buffer 180 via a destructor function, once all of the packets stored in the buffer 180 have been processed.

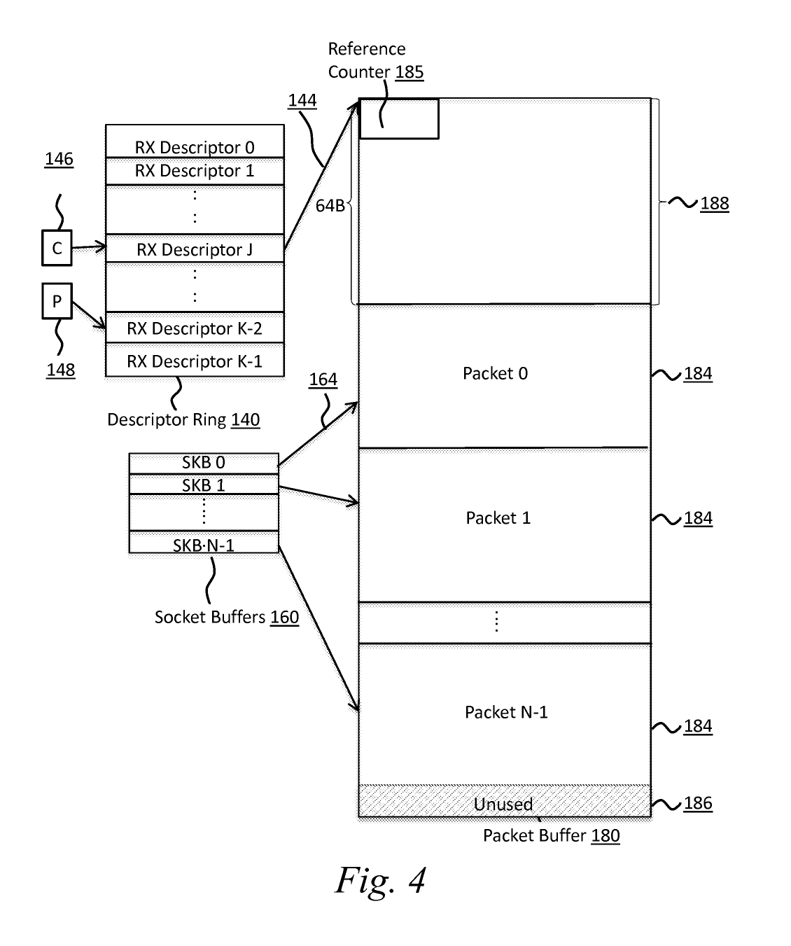

FIG. 4 is a block diagram of an implementation of a receive side packet aggregation system for enhanced resource utilization in accordance with a third embodiment.

According to the third embodiment, the receive side packet aggregation system 100 (see FIG. 1) may include a reference counter 185 in the packet buffer 180. For example, referring to FIG. 4, a reference counter 185 of a predetermined size, such as 1B, 2B, 4B, etc., may be stored at the start location of the RSB block 188. The network driver may process each RSB block 188 to create socket buffers that are provided to the networking protocol stack of the operating system. In some such implementations, the network driver may reuse part or all of the portion of packet buffer 180 including RSBs 182 to implement reference counter 185, after the SKBs have been created.

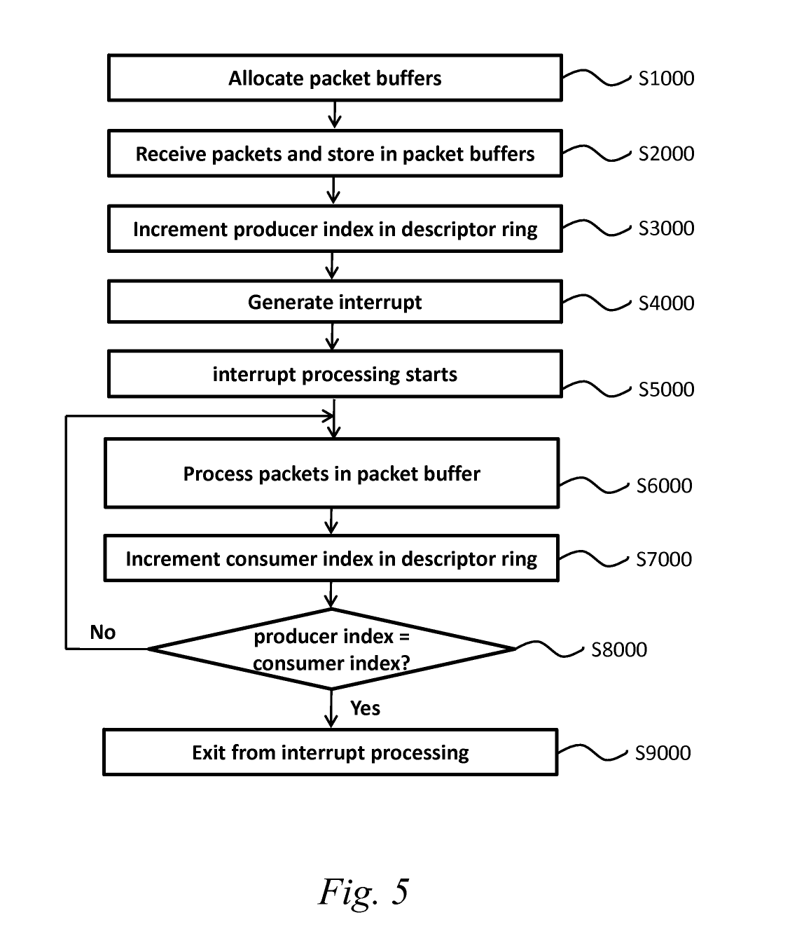

The network driver 15 (see FIG. 1) may increment a value of the reference counter 185, upon generating SKBs, as discussed below in connection with FIG. 5, or responsive to storing each of the multiple packets 184 in the packet buffer 180. Any time the networking protocol stack processes a packet, the networking protocol stack may call a destructor function to de-allocate an SKB corresponding to a packet stored in the packet buffer 180 and decrement the value of the reference counter 185. The networking protocol stack may determine that the value of the reference counter 185 has been decremented to a starting value, e.g., “0”, and provide to the operating system an identification that the allocated memory for the packet buffer 180 may be de-allocated, responsive to the determination.

Referring to FIG. 4, the network interface 120 may receive from the operating system of the device 10, an identification of a contiguous region of memory (e.g., the contiguous region of the RSB block 188, packets 184, and unused space 186) allocated for buffering a packet. For example, a network driver may allocate a region of memory for a packet buffer and provide an identification of the allocated region to the network interface 120 via an RX descriptor, as discussed above in connection with FIGS. 2-3. The network interface 120 may store multiple packets within the contiguous region of memory.

The network driver 15 may increment a value of the reference counter 185 for each packet stored within the contiguous region of memory. The network driver 15 may generate corresponding multiple SKBs, each of which can identify a packet of the multiple packets and a storage location of that packet within the contiguous region of memory. The network driver 15 may process a packet of the multiple packets stored within the contiguous region of memory. The networking protocol stack may decrement the value of the reference counter 185, responsive to processing the packet. The networking protocol stack may determine that the value of the reference counter 185 is equal to a predetermined value (e.g., “0”) and may request the operating system to de-allocate the contiguous region of memory, responsive to the determination.

FIG. 5 is a flow chart of an implementation of a method for processing packets using a receive side packet aggregation system in accordance with an embodiment.

At step S1000, the network driver 15 running on the processor 12 may allocate packet buffers 180. Before the initial allocation of a packet buffer occurs, the consumer index 146 and the producer index 148 may be set to the same location of an RX descriptor of the descriptor ring 140. The network driver 15 of the device 10 may request, from the operating system executed by the processor 12 of the device 10, allocation of a predetermined amount of memory of the device 10 for creating a single packet buffer 180. For example, the predetermined amount of memory for a single packet buffer 180 may be 2 KB; however the predetermined amount of memory according to the present disclosure is not limited thereto. Alternatively, the network driver 15 may request allocation of memory for creating multiple packet buffers 180 based on the predetermined amount of memory. The network interface 120 may receive, from the operating system, an identification (e.g., location information) of the allocated memory. In many implementations, the operating system may not know or may be agnostic to the receive side packet aggregation, and may utilize standard procedures for allocating a single packet buffer. In such implementations, the operating system need not be modified, as the network interface and network driver perform all steps necessary for aggregation.

At step S2000, the receive side packet aggregation system 100 may receive packets and store them in a single packet buffer or multiple packet buffers of the allocated memory. The network interface 120 may store a first received packet (e.g., packet “0” in FIG. 2), which is smaller than the predetermined amount of memory, in a corresponding packet buffer, and subsequently store a second received packet (e.g., packet “1” in FIG. 2), which is smaller than a difference between the predetermined amount of memory and a size of the first received packet, in the packet buffer 180. The network interface 120 also may generate or populate a status record for each received packet: e.g., a first status record (e.g., a first RSB 182 in FIG. 2) for the first received packet, a second status record (e.g., a second RSB 182 in FIG. 2) for the second received packet, etc., and store the generated RSBs 182 in the packet buffer 180. The RSBs may be stored next to the corresponding packets, respectively (see FIG. 2), or may be stored as a RSB block 188 at the start location of the packet buffer 180 (see FIGS. 3 and 4).

The first RSB may include a predetermined bit (e.g., “M” bit indicating “more” bit, see FIG. 2) set to a first value (e.g., “1”) to indicate the presence of the second packet in the packet buffer 180. The first RSB may further include a length of the first received packet and the second RSB may further include a length of the second received packet. The network interface 120 may determine to store a third received packet (e.g., packet “2” in FIG. 2) in the packet buffer 180. The network interface 120 may add each packet length identified in an RSB stored in the packet buffer 180 until reaching an RSB having the “M” bit set to a second value (e.g., “0”) to indicate an absence of any further packets in the packet buffer 180. For example, in one implementation, the network interface may store a first packet into the packet buffer 180 and may create or populate an RSB record for the first packet with an “M” bit set to the second value, indicating an absence of any further packets. The packet buffer 180 may have additional space for storing packets, depending on the length of the first packet. Upon receiving a second packet, the network interface may determine that the second packet may fit within the additional space. Responsive to the determination, the network interface may store the second packet in the buffer; create or populate an RSB for the second packet with an “M” bit set to the second value; and modify the RSB for the first packet to change the “M” bit to the first value, indicating the presence of the second packet. Upon receipt of a third packet, the network interface may again determine whether the third packet will fit within the buffer, by adding the lengths in the RSBs associated with the first and second packet to identify a start location for the third packet. The third received packet may then be stored in the allocated memory at the start location.

Packets may be written to the packet buffer 180 using direct memory access 14, in some implementations, or via system bus 11. The network driver of the operating system may then read the packets directly from memory. For a reduced number of transactions, a portion of the first packet and a portion of the second packet may be provided to the system bus 11, such that the total size of the portions is equal to a transaction size (e.g., 64B) corresponding to a predetermined maximum throughput of the system bus 11. With this packet provision scheme, if there is close to 2 KB of data available in each packet buffer, a majority of transactions over the system bus 11 to write into the memory can fully utilize a system bandwidth. For example, when 65B back-to-back packets are received and the system bus has 64B transaction size for a maximum throughput, 28 packets will be stored within a 2 KB packet buffer, resulting in 31 fully-utilized transactions (i.e., 31 transactions of 64B size) and 1 non-fully-utilized transaction (i.e., one transaction of 32B size), thereby significantly reducing system inefficiencies. Specifically, in some embodiments, memory write bandwidth utilization can be improved so that majority of transactions have size of full memory (e.g., DRAM) burst length. For example, in case of 65B packets, 32-bit (or 4B) wide DRAM interface and DRAM burst length of 8, without packet aggregation, there will be two fully-utilized transactions (4B*8=32B) and one non-fully-utilized (1B) transaction, for each packet, leading to 56 (28*2) fully-utilized transactions and 28 non-fully-utilized transactions, for 28 packets. On the other hand, when the packet aggregation system is deployed, there will be 56 (28*2) fully-utilized transactions and only one non-fully-utilized transaction using a 2 KB packet buffer, in implementations in which one packet is 71B long (65B packet+4B RSB+2B prepended to packet to align IP protocol headers to 32-bit boundary=71B) and the 2 KB packet buffer is filled up with 28 packets (Integer of 2048B/71B=28 packets). By aggregating smaller packets in a packet buffer, the operating system can allocate fewer buffers than without aggregation, thereby more efficiently using the available system DRAM space. Furthermore, system design constraints of a DRAM controller can be relaxed because the DRAM controller does not need to grant memory access for every single packet.

In some implementations, to accomplish packet aggregation, the network interface may first create a packet aggregate structure in its local memory, corresponding to packet buffer 180, for aggregating received packets. The network interface may then move data from its local memory into the system memory 13 (e.g. via DMA), using optimally sized system bus transactions (e.g. 64B) as discussed above.

At step S3000, when each of one or more packet buffers is filled with one or more packets, the producer index 148 may be incremented to have the memory address of an RX descriptor which has the memory address 142 of the corresponding packet buffer 180. Alternatively, a push timer may handle stalled packets in the case where less than 2 KB is stored and a predetermined period of RX network inactivity has elapsed. That is, the producer index 148 may be incremented after a lapse of the predetermined period of RX network inactivity.

At step S4000, an interrupt to be serviced by the network driver 15 running on the processor 12 may be generated to initiate the processing of packet buffers located by RX descriptors corresponding to a location range defined by the consumer index 146 and the producer index 148 (e.g., RX descriptors (J+1) to (K−2) in FIG. 3). Here, an interrupt coalescing may be used so that the network interface 120 is not interrupted for every received packet.

At step S5000, the network driver 15 may start processing of the packet buffers located by the RX descriptors in the location range defined by the two indexes.

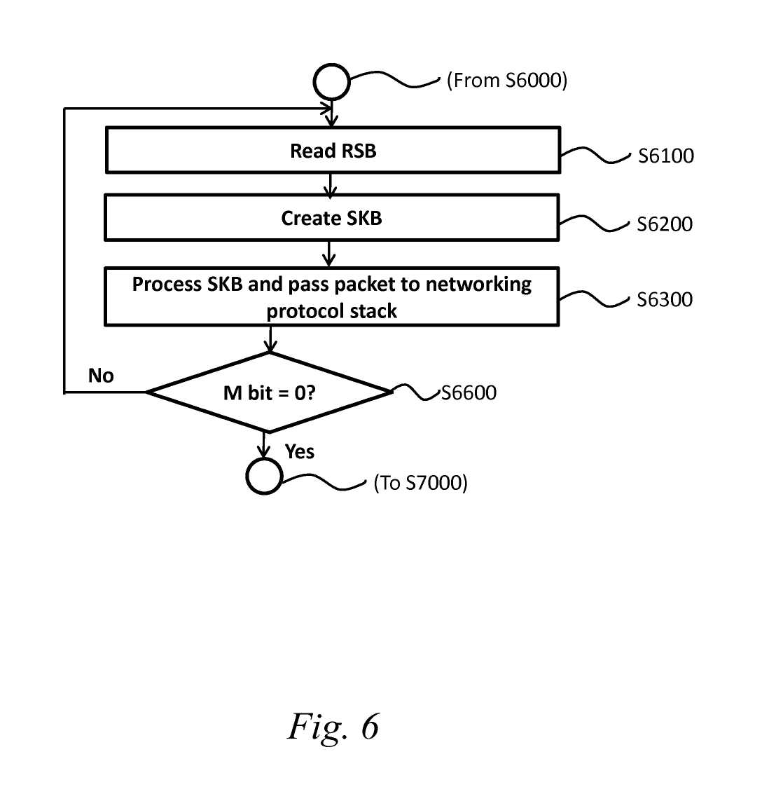

At step S6000, the network driver 15 may read the RX descriptors in the location range and process packets from a packet buffer located by the RX descriptor pointed to by the consumer index 146. The process of step S6000 will be described in detail below with reference to FIG. 6.

At step S7000, after processing all packets from the packet buffer corresponding to the previous RX descriptor, the consumer index 146 (see FIG. 4) may be incremented to point to the next RX descriptor. At step S8000, it may be determined whether the producer index 148 has the same location information as the consumer index 146. At step S9000, when it is determined that the producer index 148 has the same location information as that of the consumer index 146, the interrupt routine or routine for processing packets may be exited. Otherwise, when it is determined that the producer index 148 has different location information than that of the consumer index 146, the device 10 may repeat the processes at steps S6000 and S7000.

FIG. 6 is a flow chart of an implementation of a method for processing packets from a packet buffer using a receive side packet aggregation system in accordance with an embodiment. FIG. 6 illustrates the process of step S6000 (see FIG. 5) in detail as follows.

At S6100, the network driver 15 may read a first RSB using the RX descriptor pointed by the consumer index 146 or read a next RSB using the previously read RSB. The first RSB may be located using the memory address (e.g., 142 or 144 in FIGS. 2-4) included in the RX descriptor. The next RSB may be located by adding the address of the packet corresponding to the previously read RSB and the length of that packet (see FIG. 2). Alternatively, the next RSB may be located by adding the address of the previously read RSB and the length of the RSB (see FIGS. 3 and 4).

At S6200, a socket buffer 160 may be created corresponding to the RSB read at step S6100 to have the memory address of the packet corresponding to the RSB. A value of a counter (e.g., the reference counter 185 in FIG. 4) may be incremented responsive to creating each socket buffer.

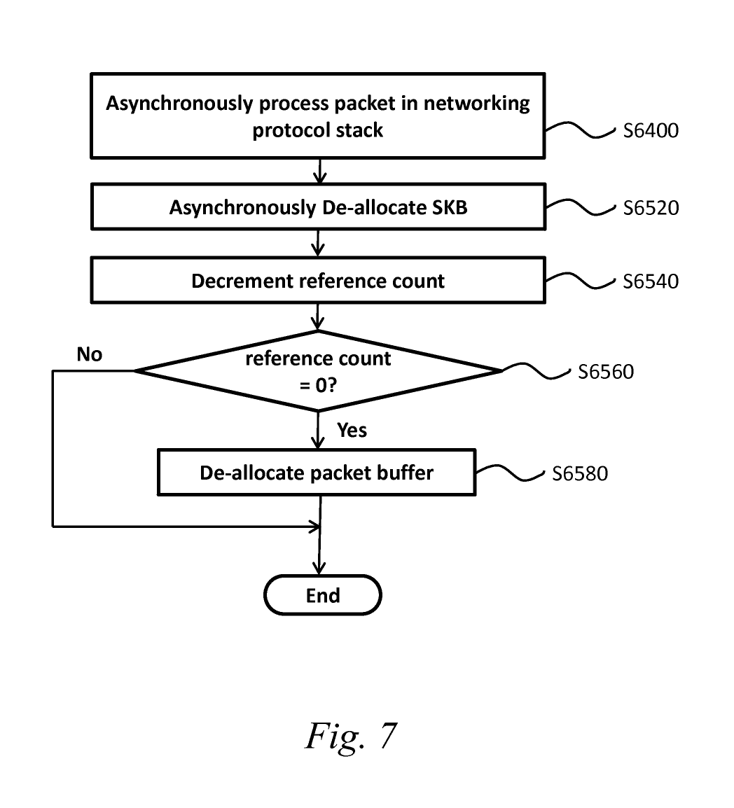

At step S6300, the network driver 15 may pass or enqueue the SKB created at step S6200 into a networking protocol stack queue. The enqueued SKBs and their corresponding packets will be processed later and asynchronously by the networking protocol stack in the OS kernel (see step S6400 below with reference to FIG. 7).

At step S6600, if the previously read RSB has the “M” bit set to the second value, e.g., “0”, the control may be transferred to step S7000 (see FIG. 5). Otherwise, if the previously read RSB has the “M” bit set to the first value, e.g., “1”, the steps S6100-S6300 may be repeated.

FIG. 7 is a flow chart of an implementation of a method for processing packets and deallocating a socket buffer and packet buffer in accordance with an embodiment.

At step S6400, the networking protocol stack may asynchronously process packets using the corresponding SKBs.

At step S6520, after a packet is processed by the networking protocol stack, the SKB corresponding to the packet may be de-allocated asynchronously by the networking protocol stack. At step S6540, the reference counter 185 (see FIG. 4) may be decremented asynchronously by the networking protocol stack. The networking protocol stack may determine that the value of the reference counter 185 indicates that all packets stored in the packet buffer 180 have been processed. For example, if the reference counter is initially set to “0”, the “0” value of the reference counter 185 as a result of a number of increments and decrements will indicate that all packets stored in the packet buffer 180 have been processed.

At step S6560, it may be determined whether the reference count 185 of the packet buffer 180 equals to zero. At step S6580, when it is determined that the reference count 185 of the packet buffer 180 equals to zero, the packet buffer 180 may be de-allocated. The network protocol stack may provide to the operating system an identification that the allocated memory for the packet buffer 180 may be de-allocated. Alternatively, the packet buffer may be reused without de-allocation for storing and processing another set of packets.

In some embodiments, system bus bandwidth utilization can be improved so that majority of transactions fully utilize an available system bus bandwidth, and the overall system bus latency can be reduced. In the example of 65B packets and 64B system bus transactions, when using 2 KB packet buffers, the total number of transaction can be 32, where 31 64B transactions fully use the 64B transaction size, and only one transaction, e.g., the 32^{nd} transaction, does not fully use the 64B transaction size.

In some embodiments, memory write bandwidth utilization can be improved so that majority of transactions have size of full memory (e.g., DRAM) burst length. For example, in case of 65B packets, 32-bit (or 4B) wide DRAM interface and DRAM burst length of 8, without packet aggregation, there will be two fully-utilized transactions (4B*8=32B) and one non-fully-utilized (1B) transaction, for each packet, leading to 56 (28*2) fully-utilized transactions and 28 non-fully-utilized transactions, for 28 packets. On the other hand, when the packet aggregation system is deployed, there will be 56 (28*2) fully-utilized transactions and only one non-fully-utilized transaction using a 2 KB packet buffer, in implementations in which one packet is 71B long (65B packet+4B RSB+2B prepended to packet to align IP protocol headers to 32-bit boundary=71B) and the 2 KB packet buffer is filled up with 28 packets (Integer of 2048B/71B=28 packets). Moreover, by aggregating smaller packets in a packet buffer, the operating system can allocate fewer buffers than without aggregation, thereby more efficiently using the available system DRAM space. Furthermore, system design constraints of a DRAM controller can be relaxed because the DRAM controller does not need to grant memory access for every single packet.

In some embodiments, packets can be aggregated in 2 KB collections of memory (e.g. packet buffers), and the system interrupt can be generated based on the number of consumed packet buffers instead of that of received packets, thereby greatly reducing the total number of RX interrupts. For example, 65B back-to-back packets may result in 1.47M interrupts per second on a 1 Gb/s link if the interrupt is generated for every packet, while the packet aggregation system can reduce the total number of interrupts up to 52,500 (=1.47M/28) interrupts per second because the interrupt is generated for every 28 packets stored in each packet buffer. Furthermore, by using a simple reference counter, interrupt moderation can further reduce the number of interrupts.

In one aspect, the present disclosure describes a method for enhanced resource utilization. The method includes requesting, by a network driver of a device from an operating system executed by a processor of the device, allocation of a predetermined amount of memory of the device; receiving, by the network driver from the operating system, an identification of the allocated memory; storing, by a network interface, a first received packet in the allocated memory, the first received packet smaller than the predetermined amount of memory; and storing, by the network interface a second received packet in the allocated memory, the second received packet smaller than a difference between the predetermined amount of memory and a size of the first received packet.

In some implementations, the method further includes generating, by the network interface, a first status record for the first received packet and a second status record for the second received packet; and storing, by the network interface, the generated first and second status records in the allocated memory. In some implementations, the first status record further includes a predetermined bit set to a first value to indicate the presence of the second packet in the allocated memory. In other implementations, the first status record further includes a length of the first received packet and the second status record further includes a length of the second received packet.

In some implementations, the method further includes determining, by the network interface, to store a third received packet in the allocated memory; adding, by the network interface, each packet length identified in a status record stored in the allocated memory until reaching a status record having the predetermined bit set to a second value to indicate an absence of any further packets in the allocated memory; and storing the third received packet in the allocated memory at a start location equal to the added packet lengths.

In some implementations, the method further includes incrementing, by the network driver, a value of a reference counter.

In some implementations, the method further includes reading the first packet from the allocated memory; and decrementing the value of the counter, responsive to processing of the first packet.

In some implementations, the method includes determining that the value of the counter indicates that all packets stored in the allocated memory have been read; and providing to the operating system an identification that the allocated memory may be de-allocated.

In some implementations, a system bus of the device has a predetermined maximum throughput. In such implementations, the method further includes providing to the system bus, by the network interface, a portion of the first received packet and a portion of the second packet, the total size of the portions equal to a maximum transaction size corresponding to the predetermined maximum throughput.

In another aspect, the present disclosure describes a system for enhanced resource utilization. The system includes a network interface with access to memory of a device, in communication with an operating system of the device. The network interface is configured for receiving, by a network driver of the device and from the operating system, an identification of a predetermined amount of the memory for a packet buffer, storing a plurality of packets in the allocated memory, a total size of the plurality of packets smaller than or equal to the predetermined amount of memory, generating a status record for each received packet stored in the allocated memory, and storing the generated status records in the allocated memory.

In some implementations, each status record for each received packet comprises a predetermined bit set to a first value to indicate the presence of another packet stored at a location in the allocated memory following said received packet, or set to a second value to indicate the absence of said another packet.

In some implementations, each status record for each received packet further includes an identification of a length of said received packet.

In some implementations, iteratively for each received packet, the network interface is further configured to add the packet length identified in each status record stored in the allocated memory until reaching a status record having the predetermined bit set to the second value, and store said received packet in the allocated memory at a start location equal to the added packet lengths. In some implementations, the system further includes a counter, and wherein the network driver is further configured to increment a value of the counter.

### B. Computing and Network Environment

The following IEEE standard(s), including any draft versions of such standard(s), are hereby incorporated herein by reference in their entirety and are made part of the present disclosure for all purposes: IEEE P802.3™; IEEE P802.11n™; and IEEE P802.11ac™. Although this disclosure may reference aspects of these standard(s), the disclosure is in no way limited by these standard(s).

Having discussed specific embodiments of the present solution, it may be helpful to describe aspects of the operating environment as well as associated system components (e.g., hardware elements) in connection with the methods and systems described herein. Referring to FIG. 8A, an embodiment of a network environment is depicted. In brief overview, the network environment includes wired devices, e.g., a laptop connected via a standard Ethernet (CAT5/6) cable, and a wireless communication system that includes one or more access points 806, one or more wireless communication devices 802 and a network hardware component 892. The wireless communication devices 802 may for example include laptop computers 802, tablets 802, personal computers 802 and/or cellular telephone devices 802. The details of an embodiment of each wireless communication device and/or access point are described in greater detail with reference to FIGS. 8B and 8C. The network environment can be an ad hoc network environment, an infrastructure wireless network environment, a subnet environment, etc. in one embodiment.

The access points (APs) 806 may be operably coupled to the network hardware 892 via local area network connections. The network hardware 892, which may include a router, gateway, switch, bridge, modem, system controller, appliance, etc., may provide a local area network connection for the communication system. Each of the access points 806 may have an associated antenna or an antenna array to communicate with the wireless communication devices 802 in its area via wireless local area network connections. The wireless communication devices 802 may register with a particular access point 806 to receive services from the communication system (e.g., via a SU-MIMO or MU-MIMO configuration). For direct connections (e.g., point-to-point communications), some wireless communication devices 802 may communicate directly via an allocated channel and communications protocol. Some of the wireless communication devices 802 may be mobile or relatively static with respect to the access point 806.

In some embodiments an access point 806 includes a device or module (including a combination of hardware and software) that allows wireless communication devices 802 to connect to a wired network using Wi-Fi, or other standards. An access point 806 may sometimes be referred to as an wireless access point (WAP). An access point 806 may be configured, designed and/or built for operating in a wireless local area network (WLAN). An access point 806 may connect to a router (e.g., via a wired network) as a standalone device in some embodiments. In other embodiments, an access point can be a component of a router. An access point 806 can provide multiple devices 802 access to a network. An access point 806 may, for example, connect to a wired Ethernet connection and provide wireless connections using radio frequency links for other devices 802 to utilize that wired connection. An access point 806 may be built and/or configured to support a standard for sending and receiving data using one or more radio frequencies. Those standards, and the frequencies they use may be defined by the IEEE (e.g., IEEE 802.11 standards). An access point may be configured and/or used to support public Internet hotspots, and/or on an internal network to extend the network's Wi-Fi signal range.

In some embodiments, the access points 806 may be used for (e.g., in-home or in-building) wireless networks (e.g., IEEE 802.11, Bluetooth, ZigBee, any other type of radio frequency based network protocol and/or variations thereof). Each of the wireless communication devices 802 may include a built-in radio and/or is coupled to a radio. Such wireless communication devices 802 and/or access points 806 may operate in accordance with the various aspects of the disclosure as presented herein to enhance performance, reduce costs and/or size, and/or enhance broadband applications. Each wireless communication devices 802 may have the capacity to function as a client node seeking access to resources (e.g., data, and connection to networked nodes such as servers) via one or more access points 806.

The network connections may include any type and/or form of network and may include any of the following: a point-to-point network, a broadcast network, a telecommunications network, a data communication network, a computer network. The topology of the network may be a bus, star, or ring network topology. The network may be of any such network topology as known to those ordinarily skilled in the art capable of supporting the operations described herein. In some embodiments, different types of data may be transmitted via different protocols. In other embodiments, the same types of data may be transmitted via different protocols.

The communications device(s) 802 and access point(s) 806 may be deployed as and/or executed on any type and form of computing device, such as a computer, network device or appliance capable of communicating on any type and form of network and performing the operations described herein. FIGS. 8B and 8C depict block diagrams of a computing device 800 useful for practicing an embodiment of the wireless communication devices 802 or the access point 806. As shown in FIGS. 8B and 8C, each computing device 800 includes a central processing unit 821, and a main memory unit 822. As shown in FIG. 8B, a computing device 800 may include a storage device 828, an installation device 816, a network interface 818, an I/O controller 823, display devices 824a-824n, a keyboard 826 and a pointing device 827, such as a mouse. The storage device 828 may include, without limitation, an operating system and/or application software. As shown in FIG. 8C, each computing device 800 may also include additional optional elements, such as a memory port 803, a bridge 870, one or more input/output devices 830a-830n (generally referred to using reference numeral 830), and a cache memory 840 in communication with the central processing unit 821.

The central processing unit 821 is any logic circuitry that responds to and processes instructions fetched from the main memory unit 822. In many embodiments, the central processing unit 821 is provided by a microprocessor unit, such as: those manufactured by Intel Corporation of Mountain View, Calif.; those manufactured by International Business Machines of White Plains, N.Y.; or those manufactured by Advanced Micro Devices of Sunnyvale, Calif. The computing device 800 may be based on any of these processors, or any other processor capable of operating as described herein.

Main memory unit 822 may be one or more memory chips capable of storing data and allowing any storage location to be directly accessed by the microprocessor 821, such as any type or variant of Static random access memory (SRAM), Dynamic random access memory (DRAM), Ferroelectric RAM (FRAM), NAND Flash, NOR Flash and Solid State Drives (SSD). The main memory 822 may be based on any of the above described memory chips, or any other available memory chips capable of operating as described herein. In the embodiment shown in FIG. 8B, the processor 821 communicates with main memory 822 via a system bus 850 (described in more detail below). FIG. 8C depicts an embodiment of a computing device 800 in which the processor communicates directly with main memory 822 via a memory port 803. For example, in FIG. 8C the main memory 822 may be DRDRAM.

FIG. 8C depicts an embodiment in which the main processor 821 communicates directly with cache memory 840 via a secondary bus, sometimes referred to as a backside bus. In other embodiments, the main processor 821 communicates with cache memory 840 using the system bus 850. Cache memory 840 typically has a faster response time than main memory 822 and is provided by, for example, SRAM, BSRAM, or EDRAM. In the embodiment shown in FIG. 8C, the processor 821 communicates with various I/O devices 830 via a local system bus 850. Various buses may be used to connect the central processing unit 821 to any of the I/O devices 830, for example, a VESA VL bus, an ISA bus, an EISA bus, a MicroChannel Architecture (MCA) bus, a PCI bus, a PCI-X bus, a PCI-Express bus, or a NuBus. For embodiments in which the I/O device is a video display 824, the processor 821 may use an Advanced Graphics Port (AGP) to communicate with the display 824. FIG. 8C depicts an embodiment of a computer 800 in which the main processor 821 may communicate directly with I/O device 830b, for example via HYPERTRANSPORT, RAPIDIO, or INFINIBAND communications technology. FIG. 8C also depicts an embodiment in which local busses and direct communication are mixed: the processor 821 communicates with I/O device 830a using a local interconnect bus while communicating with I/O device 830b directly.

A wide variety of I/O devices 830a-830n may be present in the computing device 800. Input devices include keyboards, mice, trackpads, trackballs, microphones, dials, touch pads, touch screen, and drawing tablets. Output devices include video displays, speakers, inkjet printers, laser printers, projectors and dye-sublimation printers. The I/O devices may be controlled by an I/O controller 823 as shown in FIG. 8B. The I/O controller may control one or more I/O devices such as a keyboard 826 and a pointing device 827, e.g., a mouse or optical pen. Furthermore, an I/O device may also provide storage and/or an installation medium 816 for the computing device 800. In still other embodiments, the computing device 800 may provide USB connections (not shown) to receive handheld USB storage devices such as the USB Flash Drive line of devices manufactured by Twintech Industry, Inc. of Los Alamitos, Calif.

Referring again to FIG. 8B, the computing device 800 may support any suitable installation device 816, such as a disk drive, a CD-ROM drive, a CD-R/RW drive, a DVD-ROM drive, a flash memory drive, tape drives of various formats, USB device, hard-drive, a network interface, or any other device suitable for installing software and programs. The computing device 800 may further include a storage device, such as one or more hard disk drives or redundant arrays of independent disks, for storing an operating system and other related software, and for storing application software programs such as any program or software 820 for implementing (e.g., configured and/or designed for) the systems and methods described herein. Optionally, any of the installation devices 816 could also be used as the storage device. Additionally, the operating system and the software can be run from a bootable medium.

Furthermore, the computing device 800 may include a network interface 818 to interface to the network 804 through a variety of connections including, but not limited to, standard telephone lines, LAN or WAN links (e.g., 802.11, T1, T3, 56 kb, X.25, SNA, DECNET), broadband connections (e.g., ISDN, Frame Relay, ATM, Gigabit Ethernet, Ethernet-over-SONET), wireless connections, or some combination of any or all of the above. Connections can be established using a variety of communication protocols (e.g., TCP/IP, IPX, SPX, NetBIOS, Ethernet, ARCNET, SONET, SDH, Fiber Distributed Data Interface (FDDI), RS232, IEEE 802.11, IEEE 802.11a, IEEE 802.11b, IEEE 802.11g, IEEE 802.11n, IEEE 802.11ac, IEEE 802.11ad, CDMA, GSM, WiMax and direct asynchronous connections). In one embodiment, the computing device 800 communicates with other computing devices 800′ via any type and/or form of gateway or tunneling protocol such as Secure Socket Layer (SSL) or Transport Layer Security (TLS). The network interface 818 may include a built-in network adapter, network interface card, PCMCIA network card, card bus network adapter, wireless network adapter, USB network adapter, modem or any other device suitable for interfacing the computing device 800 to any type of network capable of communication and performing the operations described herein.

In some embodiments, the computing device 800 may include or be connected to one or more display devices 824a-824n. As such, any of the I/O devices 830a-830n and/or the I/O controller 823 may include any type and/or form of suitable hardware, software, or combination of hardware and software to support, enable or provide for the connection and use of the display device(s) 824a-824n by the computing device 800. For example, the computing device 800 may include any type and/or form of video adapter, video card, driver, and/or library to interface, communicate, connect or otherwise use the display device(s) 824a-824n. In one embodiment, a video adapter may include multiple connectors to interface to the display device(s) 824a-824n. In other embodiments, the computing device 800 may include multiple video adapters, with each video adapter connected to the display device(s) 824a-824n. In some embodiments, any portion of the operating system of the computing device 800 may be configured for using multiple displays 824a-824n. One ordinarily skilled in the art will recognize and appreciate the various ways and embodiments that a computing device 800 may be configured to have one or more display devices 824a-824n.

In further embodiments, an I/O device 830 may be a bridge between the system bus 850 and an external communication bus, such as a USB bus, an Apple Desktop Bus, an RS-232 serial connection, a SCSI bus, a FireWire bus, a FireWire 800 bus, an Ethernet bus, an AppleTalk bus, a Gigabit Ethernet bus, an Asynchronous Transfer Mode bus, a FibreChannel bus, a Serial Attached small computer system interface bus, a USB connection, or a HDMI bus.

A computing device 800 of the sort depicted in FIGS. 8B and 8C may operate under the control of an operating system, which control scheduling of tasks and access to system resources. The computing device 800 can be running any operating system such as any of the versions of the MICROSOFT WINDOWS operating systems, the different releases of the Unix and Linux operating systems, any version of the MAC OS for Macintosh computers, any embedded operating system, any real-time operating system, any open source operating system, any proprietary operating system, any operating systems for mobile computing devices, or any other operating system capable of running on the computing device and performing the operations described herein. Typical operating systems include, but are not limited to: Android, produced by Google Inc.; WINDOWS 7 and 8, produced by Microsoft Corporation of Redmond, Wash.; MAC OS, produced by Apple Computer of Cupertino, Calif.; WebOS, produced by Research In Motion (RIM); OS/2, produced by International Business Machines of Armonk, N.Y.; and Linux, a freely-available operating system distributed by Caldera Corp. of Salt Lake City, Utah, or any type and/or form of a Unix operating system, among others.

The computer system 800 can be any workstation, telephone, desktop computer, laptop or notebook computer, server, handheld computer, mobile telephone or other portable telecommunications device, media playing device, a gaming system, mobile computing device, or any other type and/or form of computing, telecommunications or media device that is capable of communication. The computer system 800 has sufficient processor power and memory capacity to perform the operations described herein.

In some embodiments, the computing device 800 may have different processors, operating systems, and input devices consistent with the device. For example, in one embodiment, the computing device 800 is a smart phone, mobile device, tablet or personal digital assistant. In still other embodiments, the computing device 800 is an Android-based mobile device, an iPhone smart phone manufactured by Apple Computer of Cupertino, Calif., or a Blackberry or WebOS-based handheld device or smart phone, such as the devices manufactured by Research In Motion Limited. Moreover, the computing device 800 can be any workstation, desktop computer, laptop or notebook computer, server, handheld computer, mobile telephone, any other computer, or other form of computing or telecommunications device that is capable of communication and that has sufficient processor power and memory capacity to perform the operations described herein.

Although the disclosure may reference one or more “users”, such “users” may refer to user-associated devices or stations (STAs), for example, consistent with the terms “user” and “multi-user” typically used in the context of a multi-user multiple-input and multiple-output (MU-MIMO) environment.

Although examples of communications systems described above may include devices and APs operating according to an 802.11 standard, it should be understood that embodiments of the systems and methods described can operate according to other standards and use wireless communications devices other than devices configured as devices and APs. For example, multiple-unit communication interfaces associated with cellular networks, satellite communications, vehicle communication networks, and other non-802.11 wireless networks can utilize the systems and methods described herein to achieve improved overall capacity and/or link quality without departing from the scope of the systems and methods described herein.

It should be noted that certain passages of this disclosure may reference terms such as “first” and “second” in connection with devices, mode of operation, transmit chains, antennas, etc., for purposes of identifying or differentiating one from another or from others. These terms are not intended to merely relate entities (e.g., a first device and a second device) temporally or according to a sequence, although in some cases, these entities may include such a relationship. Nor do these terms limit the number of possible entities (e.g., devices) that may operate within a system or environment.

It should be understood that the systems described above may provide multiple ones of any or each of those components and these components may be provided on either a standalone machine or, in some embodiments, on multiple machines in a distributed system. In addition, the systems and methods described above may be provided as one or more computer-readable programs or executable instructions embodied on or in one or more articles of manufacture. The article of manufacture may be a floppy disk, a hard disk, a CD-ROM, a flash memory card, a PROM, a RAM, a ROM, or a magnetic tape. In general, the computer-readable programs may be implemented in any programming language, such as LISP, PERL, C, C++, C#, PROLOG, or in any byte code language such as JAVA. The software programs or executable instructions may be stored on or in one or more articles of manufacture as object code.

While the foregoing written description of the methods and systems enables one of ordinary skill to make and use what is considered presently to be the best mode thereof, those of ordinary skill will understand and appreciate the existence of variations, combinations, and equivalents of the specific embodiment, method, and examples herein. The present methods and systems should therefore not be limited by the above described embodiments, methods, and examples, but by all embodiments and methods within the scope and spirit of the disclosure.

We claim:

1. A method for enhanced resource utilization, comprising:
requesting, by a network driver of a device from an operating system executed by a processor of the device, allocation of a predetermined amount of memory of the device;
receiving, by the network driver from the operating system, an identification of the allocated memory;
storing, by a network interface, a first received packet in the allocated memory, the first received packet smaller than the predetermined amount of memory; and
storing, by the network interface, a second received packet in the allocated memory, the second received packet smaller than a difference between the predetermined amount of memory and a size of the first received packet.

2. The method of claim 1, further comprising:
generating, by the network interface, a first status record for the first received packet and a second status record for the second received packet; and
storing, by the network interface, the generated first and second status records in the allocated memory.

3. The method of claim 2, wherein the first status record further comprises a predetermined bit set to a first value to indicate the presence of the second packet in the allocated memory.

4. The method of claim 3, wherein the first status record further comprises a length of the first received packet and the second status record further comprises a length of the second received packet.

5. The method of claim 4, further comprising:
determining, by the network interface, to store a third received packet in the allocated memory;
adding, by the network interface, each packet length identified in a status record stored in the allocated memory until reaching a status record having the predetermined bit set to a second value to indicate an absence of any further packets in the allocated memory; and
storing the third received packet in the allocated memory at a start location equal to the added packet lengths.

6. The method of claim 1, further comprising incrementing, by the network driver, a value of a counter, responsive to storing the first packet by the network interface.

7. The method of claim 6, further comprising:
reading the first packet from the allocated memory, by the network driver; and
decrementing the value of the counter, responsive to processing of the first packet.

8. The method of claim 7, further comprising:
determining that the value of the counter indicates that all packets stored in the allocated memory have been read; and
providing to the operating system an identification that the allocated memory may be de-allocated.

9. The method of claim 1, wherein a system bus of the device has a predetermined maximum throughput, and further comprising:
providing to the system bus, by the network interface, a portion of the first received packet and a portion of the second packet, the total size of the portions equal to a maximum transaction size corresponding to the predetermined maximum throughput.

10. A system for enhanced resource utilization, comprising:
a network interface with access to memory of a device, in communication with an operating system of the device, configured for:
receiving, by a network driver of the device and from the operating system, an identification of a predetermined amount of the memory for a packet buffer,
storing a plurality of packets in the allocated memory, a total size of the plurality of packets smaller than or equal to the predetermined amount of memory,
generating a status record for each received packet stored in the allocated memory, and
storing the generated status records in the allocated memory.

11. The system of claim 10, wherein each status record for each received packet comprises a predetermined bit set to a first value to indicate the presence of another packet stored at a location in the allocated memory following said received packet, or set to a second value to indicate the absence of said another packet.

12. The system of claim 11, wherein each status record for each received packet further comprises an identification of a length of said received packet.

13. The system of claim 12, wherein, iteratively for each received packet, the network interface is further configured to:
add the packet length identified in each status record stored in the allocated memory until reaching a status record having the predetermined bit set to the second value, and
store said received packet in the allocated memory at a start location equal to the added packet lengths.

14. The system of claim 10, further comprising a counter, and wherein the network driver is configured to increment a value of the counter.

15. The system of claim 14, wherein a networking protocol stack of the device is configured to decrement the value of the counter, responsive to processing a packet of the plurality of packets from the allocated memory.

16. The system of claim 15, wherein the operating system is configured to determine that the value of the counter has been decremented to a starting value, and provide an identification that the allocated memory may be de-allocated, responsive to the determination.

17. The system of claim 10, wherein the network interface accesses the memory of the device via a system bus with a predetermined maximum throughput, and wherein the operating system is further configured to read a portion of a first packet of the plurality of packets and a portion of a second packet of the plurality of packets, the portions of the first packet and second packet equal in size to the predetermined maximum throughput.

18. A method, comprising:
receiving, by a network driver of a device from an operating system of the device, an identification of a contiguous region of memory allocated for buffering a packet;
storing, by a network interface, a plurality of packets within the contiguous region of memory;
incrementing, by the network driver, a value of a counter for each packet stored within the contiguous region of memory; and
generating, by the network driver, a corresponding plurality of socket buffer records, each socket buffer record identifying a packet of the plurality of packets and a storage location of said packet within the contiguous region of memory.

19. The method of claim 18, further comprising:
processing, by the operating system, a packet of the plurality of packets stored within the contiguous region of memory; and
decrementing, by the operating system, the value of the counter, responsive to processing the packet.

20. The method of claim 19, further comprising:
determining, by the operating system, that the value of the counter is equal to a predetermined value; and
requesting the operating system to de-allocate the contiguous region of memory, responsive to the determination.
